(19) United States
(12) Patent Application Publication
(10) Pub. No.: US 2014/0361905 A1
(43) Pub. Date: Dec. 11, 2014

(54) CONTEXT MONITORING

(71) Applicant: QUALCOMM Incorporated, San Diego, CA (US)

(72) Inventors: Shankar Sadasivam, San Diego, CA (US); Leonard Grokop, San Diego, CA (US)

(21) Appl. No.: 14/296,365

(22) Filed: Jun. 4, 2014

Related U.S. Application Data
(60) Provisional application No. 61/831,572, filed on Jun. 5, 2013.

(51) Int. Cl. G08C 17/02

(52) U.S. Cl. CPC G08C 17/02
USPC 340/870.01

(57) ABSTRACT

Disclosed is a system, apparatus, computer readable storage medium, and method to perform a transition triggered context monitoring for a mobile device. A first sensor data stream comprising data from one or more sensors at the mobile device is received. One or more features calculated from the data of the first sensor data stream may be monitored and a status change for the one or more features is detected. In response to detecting the status change, of a second sensor data stream comprising data from one or more sensors at the mobile device is collected. The second sensor data stream may be processed as a context label for a segment of the first sensor data stream and the segment beginning may be defined by the status change.

### CROSS-REFERENCE TO RELATED APPLICATIONS

This application claims the benefit of priority from U.S. Provisional Patent Application Ser. No. 61/831,572 filed on Jun. 5, 2013, entitled, “CONTEXT MONITORING,” which is herein incorporated by reference.

### FIELD

The subject matter disclosed herein relates generally to device context monitoring techniques.

### BACKGROUND

Personal electronic devices have evolved from simple mobile telephones and pagers into sophisticated computing devices capable of a wide variety of functionality such as multimedia recording and playback, event scheduling, word processing, e-commerce, etc. As a result, users of today's electronic devices are able to perform a wide range of tasks from a single, portable device that conventionally required either multiple devices or larger, non-portable equipment. Such tasks may be aided by the ability of a device to detect and use device and user context information, such as the location of a device, events occurring in the area of the device, etc., in performing and customizing functions of the device.

The usefulness of a mobile device may be enhanced when the device is able to accurately determine context (e.g., characterize a situation of the device or device user). Context may relate to one or more of: location, motion, activity, and environment. Typical machine learning and artificial intelligence algorithms may infer “universal” and “transferable” contexts of a device or user from low-level sensor data. For example, low-level sensor data can infer various motion states (walk, run, drive, etc.), universal sounds (speech, quiet, typing, etc.), and similar.

Applications may want to leverage high-level user context that is generally not universal or transferrable. For example, when determining unique user's places of relevance and audio environments a catch all accurate classifier may be difficult to implement out of the box. For example, multiple device users may share the same context “at work,” while being in completely different locations, for example at an office in New York versus working while commuting on a company shuttle bus in California may not be easily distinguishable as the same high-level user context. Similarly, the audio environment could be very different in one user's kitchen versus another, though they both share the same context of “cooking.”

High-level context inferences may be built from low-level sensor data to attempt to solve high-level context problems. For example, sleeping may be inferred from a combination of a clock to determine time, an ambient light sensor to determine darkness, a microphone to determine breathing pattern, and an accelerometer to determine movement or lack of movement. The low-level sensor data can be combined and analyzed to infer a high-level context inference of “sleeping.” Understanding high-level context (e.g., watching television, reading, socializing with friends, etc.) of a device and user may be leveraged by device applications to provide enhanced functionality to the device.

Determining high-level context labels may be particularly useful in situations where a user of a device may have limited ability or inclination to directly input context labels into the device. For example, parents may want to monitor their children's activities while they are away may not expect the children to provide an accurate account of their activities. Some example high-level context questions to be solved in a family context are: How much television did the children watch today, and what kind of shows? Did the children spend enough time doing schoolwork? Did children quarrel with each other or the caretaker? Were the children playing or talking to each other for long before going to sleep? Have they been speaking to anyone potentially untrustworthy?

Traditionally, determining high-level context inferences can require a higher level of processing power and processing to determine potentially inaccurate results. Furthermore, some implementations require overly burdensome interaction from the user of a mobile device while context is determined. In some cases even brief or isolated interaction by a user of a device may be impractical in certain situations.

### SUMMARY

Embodiments disclosed herein may relate to a method for monitoring context for a mobile device. The method includes receiving a first sensor data stream comprising data from one or more sensors at the mobile device and monitoring one or more features calculated from the data of the first sensor data stream. The method further includes detecting a first status change for one or more features within the first sensor data stream and triggering, in response to detecting the first status change, collection of a second sensor data stream comprising data from one or more sensors at the mobile device. The method also includes processing the second sensor data stream as a context label for a segment of the first sensor data stream, wherein the segment beginning is defined by the first status change.

Embodiments disclosed herein may also relate to a machine readable non-transitory storage medium with instructions to monitor context for a mobile device. The instructions include receiving a first sensor data stream comprising data from one or more sensors at the mobile device and monitoring one or more features calculated from the data of the first sensor data stream. The instructions also include detecting a first status change for one or more features within the first sensor data stream and triggering, in response to detecting the first status change, collection of a second sensor data stream comprising data from one or more sensors at the mobile device. The instructions further include processing the second sensor data stream as a context label for a segment of the first sensor data stream, wherein the segment beginning is defined by the first status change.

Embodiments disclosed herein may also relate to an apparatus that includes means for receiving a first sensor data stream comprising data from one or more sensors at the mobile device and means for monitoring one or more features calculated from the data of the first sensor data stream. The apparatus also includes means for detecting a first status change for one or more features within the first sensor data stream and means for triggering, in response to detecting the first status change, collection of a second sensor data stream comprising data from one or more sensors at the mobile device. The apparatus further includes means for processing the second sensor data stream as a context label for a segment of the first sensor data stream, wherein the segment beginning is defined by the first status change.

Embodiments disclosed herein may further relate to a data processing device including a processor and a storage device configurable to store instructions to perform a context monitoring for the data processing system. The device includes instructions to receive a first sensor data stream comprising data from one or more sensors at the mobile device and monitor one or more features calculated from the data of the first sensor data stream. The device also includes instructions detect a first status change for one or more features within the first sensor data stream and trigger, in response to detecting the first status change, collection of a second sensor data stream comprising data from one or more sensors at the mobile device. The device further includes instructions to process the second sensor data stream as a context label for a segment of the first sensor data stream, wherein the segment beginning is defined by the first status change.

Other features and advantages will be apparent from the accompanying drawings and from the detailed description.

### BRIEF DESCRIPTION OF THE DRAWINGS

FIG. 1 is an exemplary block diagram of a system in which embodiments of the invention may be practiced;

FIG. 2 illustrates a flow diagram of a Transition Triggered Context Monitoring, in one embodiment; and

FIG. 3 illustrates an exemplary time chart for clustering and context labeling.

### DETAILED DESCRIPTION

Described herein are techniques for Transition Triggered Context Monitoring (TTCM). In one embodiment, TTCM may be implemented within a portable device. The portable device may be on or nearby a user to provide label-free monitoring transparent to the user. TTCM can be valuable for users unable to actively input a context label to a mobile device. For example, children, the elderly, the incarcerated, or infirmed, to name just a few. High-level context determination for these users can be evaluated along multiple dimensions (i.e., contexts), such as place the user is located (e.g., home, park, bedroom, living room, restaurant, hospital room, gym, etc.) or the user situation (e.g., meeting, working alone, driving, having lunch, playing, watching television, working out, sleeping, etc.). For example, TTCM can monitor the ambient audio environment in the vicinity of the device to detect a change in the audio environment and trigger capture of a sample audio segment (e.g., a recording). The sample audio segment may be predetermined duration in response to the change in audio environment (e.g., “silent” context transition to “speech” context. In another example, in response to detecting a change in location (e.g., from a GPS), TTCM triggers a recording of video or sequence of still images as a segment. Other example sensors and context transitions are possible and a few additional examples are discussed below. In response to determining the segment, TTCM can store the segment in device non-volatile memory for subsequent analysis and context determination (e.g., context labeling).

In one embodiment, a third party (e.g., person or entity other than the device user or wearer) can provide context labels for segments or clusters of data captured at the mobile device. Context labels may be used to tag the segments of clusters with identifiable context details gathered during a review of the segment or cluster. For example, parents (e.g., a third party or someone with access to TTCM data recorded at the device) can monitor activities their children (e.g., a user or wearer of the device) while the parents are away from the children and the device. For example, children may be by themselves or with a babysitter between the time they return from school, and parents returning from work. The parents or an authorized party can access TTCM segments or clusters of data (e.g., in recorded log format) to the device in close proximity to the children (e.g., a mobile or wearable device). Upon reviewing the segment or cluster data, the third party can enter a description of the context.

In one embodiment, TTCM reduces power consumption by performing sparse sampling of a device environment. TTCM can determine context transitions in a sensor data stream or feed and initiate a continuous sensor data sample used for determining device context. For example, a mobile device may read sparse recording bursts from an audio data stream from a microphone to detect environment changes (e.g., transition to a different context associated with the device). Upon detecting an environment change (e.g., quiet audio environment to speech audio environment), the device can trigger a continuous sensor data sample using the same sensor, or a different sensor. For example, upon detecting a change in audio environment, the device may trigger a continuous audio recording to represent the new device context detected by the environment change.

In one embodiment, TTCM can protect user privacy by creating “privacy fences” to selectively limit the data collected according to selected configuration or authorization (i.e., allowable) settings. For example, the audio from a microphone or video from a camera may be enabled for continuous recording if a predetermined condition is met. In another example, TTCM may be enabled selectively for places (e.g., authorized/allowed locations) where continuous audio recordings may be defined (e.g., by a user or third party) as non-invasive. In the above example, child monitoring with audio and video recording (or other sensor data stream) may be enabled upon determining the mobile device is within the user's own house. In another example, continuous recordings may be enabled whenever the device is in the vicinity of certain people or nearby recognized objects. For example, the device may recognize other devices or objects as determined by Bluetooth identification, facial recognition, speech recognition, or other identification indicating the presence of specified users or objects. Segment or cluster size and type of data captured may also be limited in accordance to privacy fences. For example, settings to restrict continuous recording length to less than two minutes or limits to the resolution of captured video or images. In other embodiments, entire sensors may be enabled or disabled depending on predefined privacy settings. For example, audio may be authorized while at home, but video may be disabled or any other combination of sensors dependent of a property of the environment (e.g., location or who is nearby).

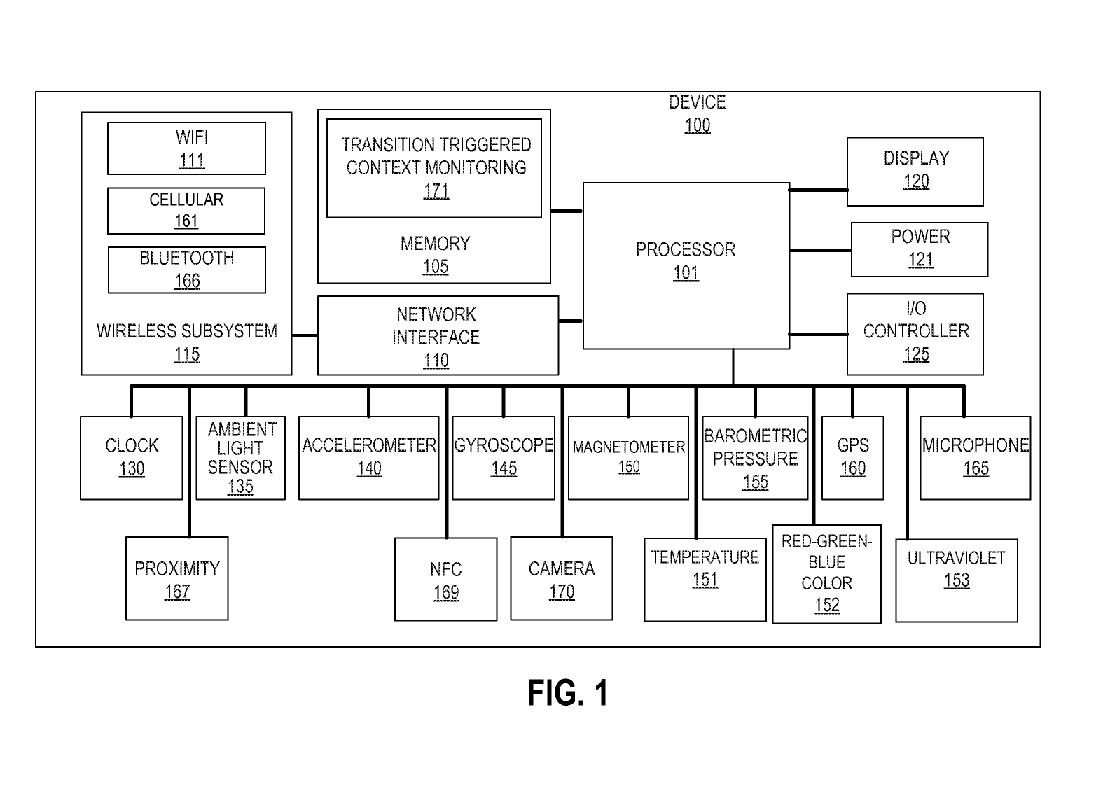

FIG. 1 is block diagram illustrating an exemplary device in which embodiments of the invention may be practiced. The device (e.g., device 100) may include one or more processors (e.g., a general purpose processor, specialized processor, or digital signal processor), a memory 105, I/O controller 125, and network interface 110. Device 100 may also include a number of device sensors coupled to one or more buses or signal lines further coupled to the processor(s) 101. It should be appreciated that device 100 may also include a display 120, a user interface (e.g., keyboard, touch-screen, or similar devices), a power device 121 (e.g., a battery), as well as other components typically associated with electronic devices. In some embodiments, device 100 may be a mobile or non-mobile device.

The device (e.g., device 100) can include sensors such as a clock 130, ambient light sensor (ALS) 135, accelerometer 140, gyroscope 145, magnetometer 150, temperature sensor 151, barometric pressure sensor 155, red-green-blue (RGB) color sensor 152, ultra-violet (UV) sensor 153, UV-A sensor, UV-B sensor, compass, proximity sensor 167, near field communication (NFC) 169, and/or Global Positioning Sensor (GPS) 160. As used herein the microphone 165, camera 170, and/or the wireless subsystem 115 (Bluetooth 166, WiFi 111, cellular 161) are also considered sensors used to analyze the environment (e.g., position) of the device. In some embodiments, multiple cameras are integrated or accessible to the device. In some embodiments, other sensors may also have multiple versions or types within a single device.

Memory 105 may be coupled to processor 101 to store instructions (e.g., TTCM) for execution by processor 101. In some embodiments, memory 105 is non-transitory. Memory 105 may also store one or more models or modules to implement embodiments described below. Thus, the memory 105 is a processor-readable memory and/or a computer-readable memory that stores software code (programming code, instructions, etc.) configured to cause the processor 101 to perform the functions described. Alternatively, one or more functions of TTCM may be performed in whole or in part in device hardware.

Memory 105 may also store data from integrated or external sensors. In addition, memory 105 may store application program interfaces (APIs) for accessing TTCM. In some embodiments, TTCM functionality can be implemented in memory 105. In other embodiments, TTCM functionality can be implemented as a module separate from other elements in the device 100. The TTCM module may be wholly or partially implemented by other elements illustrated in FIG. 1, for example in the processor 101 and/or memory 105, or in one or more other elements of the device 100.

Network interface 110 may also be coupled to a number of wireless subsystems 115 (e.g., Bluetooth 166, WiFi 111, Cellular 161, or other networks) to transmit and receive data streams through a wireless link to/from a wireless network, or may be a wired interface for direct connection to networks (e.g., the Internet, Ethernet, or other wireless systems). The mobile device may include one or more local area network transceivers connected to one or more antennas. The local area network transceiver comprises suitable devices, hardware, and/or software for communicating with and/or detecting signals to/from WAPs, and/or directly with other wireless devices within a network. In one aspect, the local area network transceiver may comprise a WiFi (802.11x) communication system suitable for communicating with one or more wireless access points.

The device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute its position from phase measurements of pilot signals transmitted from a plurality of base stations.

The device as used herein (e.g., device 100) may be a: mobile device, wireless device, cell phone, personal digital assistant, mobile computer, wearable device (e.g., watch, head mounted display, virtual reality glasses, etc.), tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 100 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 100. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above can also be considered a “mobile device” as used herein. Other uses may also be possible. While various examples given in the description below relate to mobile devices, the techniques described herein can be applied to any device for which accurate context inference is desirable.

In one embodiment, the device (e.g., device 100) is capable of monitoring the context of a user within close proximity (e.g. mobile phone) or the device may be physically attached to the user (e.g., watch, wrist band, necklace or other wearable device). In one example, a user (e.g., children, elderly people that live alone, patients suffering from physical or mental health ailments, prison inmates, etc.) may carry the device while performing normal day to day activities. In some embodiments, the device may be at a patient's bedside, worn by the elderly within their home, an anklet may be attached to an incarcerated person, or any number of other implementations and use cases are possible.

The device may communicate wirelessly with a plurality of WAPs using RF signals (e.g., 2.4 GHz, 3.6 GHz, and 4.9/5.0 GHz bands) and standardized protocols for the modulation of the RF signals and the exchanging of information packets (e.g., IEEE 802.11x). By extracting different types of information from the exchanged signals, and utilizing the layout of the network (i.e., the network geometry) the mobile device may determine position within a predefined reference coordinate system.

It should be appreciated that embodiments of the invention as will be hereinafter described may be implemented through the execution of instructions, for example as stored in the memory 105 or other element, by processor 101 of device and/or other circuitry of device and/or other devices. Particularly, circuitry of device, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Some or all of the functions, engines or modules described herein (e.g., TTCM) may be performed by the device itself and/or some or all of the functions, engines or modules described herein may be performed by another system connected through I/O controller 125 or network interface 110 (wirelessly or wired) to the device. Thus, some and/or all of the functions may be performed by another system and the results or intermediate calculations may be transferred back to the device. In some embodiments, such other device may comprise a server configured to process information in real time or near real time. In some embodiments, the other device is configured to predetermine the results, for example based on a known configuration of the device. Further, one or more of the elements illustrated in FIG. 1 may be omitted from the device. For example, one or more of the sensors (e.g., sensors 130-165) may be omitted in some embodiments.

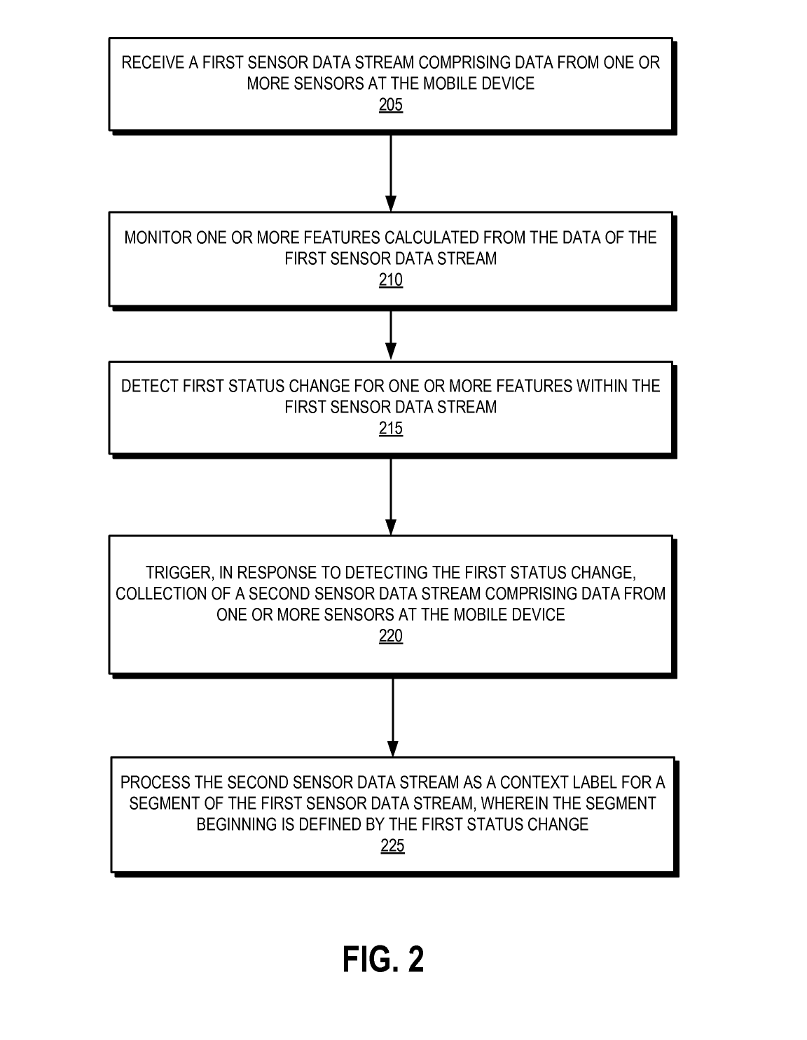

FIG. 2 illustrates a flow diagram of a Transition Triggered Context Monitoring, in one embodiment. At block 205, the embodiment (e.g., TTCM) receives a first sensor data stream comprising data from one or more sensors at the mobile device. For example, the first sensor data stream may include sensor data from one or more of the device sensors as described above (e.g., an accelerometer, a gyroscope, a magnetometer, a clock, a global positioning system, WiFi, Bluetooth, an ambient light sensor, a microphone, or a camera sensor, just to name a few).

At block 210, the embodiment monitors one or more features calculated from the data of the first sensor data stream. In one embodiment, as part of monitoring, TTCM calculates a baseline or initial feature status for one or more features. The feature status may be used by TTCM to compare to future feature calculations. TTCM may monitor features calculated from or detected within the sensor data stream to determine low-level inferences and detect segment transition events (e.g., feature status changes). Examples of low-level inferences include whether or not speech is present in an audio data stream, the motion state of a user (walking, sitting, driving, etc.) as determined based on an mobile sensor data steam (e.g., an accelerometer data stream), whether the user is at home/work/in transit/at an unknown location, whether the user is indoors or outdoors (e.g., based on the number of Global Positioning System (GPS) or other SPS satellites visible), etc. Examples of low-level features are: GPS velocity, number of Bluetooth devices within range, number of Wi-Fi access points visible, proximity sensor count, ambient light level, average camera intensity, time of day, day of week, weekday or weekend, ambient audio energy level, etc. Status of the feature may be related to a threshold value, or simply whether a feature is present within the data stream. For example, GPS velocity may have a first status when the velocity is below a threshold and a second status when the velocity is greater than or equal to the threshold. Wi-Fi access points may have a first status of “one or more access points” or a status of “no access points.” In other embodiments, TTCM may use other low-level features, status, and/or inferences.

In some embodiments, TTCM lowers its processing power usage by utilizing an intermittent first sensor data stream. TTCM can run data sensor segmentation or clustering using sparse data sampling with minimal to no reduction in accuracy of transition (e.g., feature status change) detection. For example, the embodiment can sample or poll sensors to detect low-level sensor data context changes or environment transitions (e.g., quiet state to speech state, moving state to stationary state). Instead of receiving and recording a continuous audio data stream, TTCM samples audio ambience in short bursts (e.g., 20-30 ms of audio, video, or other data). Advantageously, redundant recordings of audio environment portions that last longer than a TTCM specified recording duty-cycle period can be avoided. In some embodiments, data from the first sensor stream may be temporarily stored to volatile memory while transitions are determined. In some embodiments, none of the sensor data stream (e.g., the first sensor data stream) processed for transition detection is stored in non-volatile memory. For example, time stamps of transition events may be stored, however in some embodiments the data used for detecting the transition may not be written to disk or non-volatile memory and therefore may not be available for subsequent processing or analysis.

At block 215, the embodiment detects a first status change for one or more features within the first sensor data stream. As introduced above, TTCM may monitor a data sensor stream for a change in status of one or more features. The feature may have an initial baseline or initialized value. In response to determining a predetermined threshold is met, TTCM may change the current status of a feature. In some embodiments, two or more features may have to be met to trigger a status change.

At block 220, the embodiment triggers, in response to detecting the first status change, collection of a second sensor data stream comprising data from one or more sensors at the mobile device. In some embodiments, the second sensor data stream may be a continuous sensor data stream (e.g., a continuous and uninterrupted video or audio sample). In some embodiments, additional sensor data streams are used to determine context label. Additional sensor streams may originate from the same or different sensor from the sensor used to determine the segment or cluster transition (e.g., one or more of the sensors described above). For example, in response to determining an audio ambience transition boundary, TTCM can initiate a continuous recording (e.g., 30-120 seconds) to use as a context label or to determine a context label.

In some embodiments, the additional sensor data stream may be a sensor stream from a different sensor than was used to determine the segment/cluster transition. For example, upon detecting a change in the audio (first sensor) ambience/environment of the device and user, TTCM can activate a device camera (second sensor). In another example, upon detecting new or different WiFi access points, the device may enable an audio data stream from the microphone or may enable video capture. In some embodiments the continuous audio recording, images, or video, may be sent to a server (e.g., a server to manage parental control software, or some other central processing system). For example, by parsing video frames recorded at a transition point of the segment or cluster, the device may be able to automatically determine a high-level context for the segment or cluster. Because the video may be relatively short in duration and is likely to be relevant to the respective context, a third party, server, or mobile device can more quickly process the resulting images to infer high-level context compared with a constant on audio or video recording.

In one embodiment, TTCM collects sensor data and determines features of device's audio environment, including microphone data with speech, quiet, loud noises, or other audio segments or clusters. TTCM can obtain each segment over a specified time period (e.g., approximately one minute or other specified duration). Each segment or cluster can correspond to a distinct audio environment.

In one embodiment, TTCM collects sensor data and determines features of location of the device, including location fixes (e.g., from GPS or another satellite positioning system using latitude/longitude or other coordinates). Each segment or cluster can correspond to a macro place (i.e., a place the size of a building) that a user visits. Position fixes from a location sensor can trigger a segment as a predefined radius around a known address.

In one embodiment, TTCM collects sensor data and determines features of Wi-Fi fingerprints, including segments or clusters of visible Wi-Fi access points. WiFi fingerprints may also include an access point's respective received signal strength indication (RSSI). For example, given as a RSSI, and their respective response rates (i.e., the fraction of the time they are visible when successive scans take place) each segment or cluster can correspond to a micro place (i.e., a place the size of a room) that a user visits. TTCM may run an always-on WiFi segmentation or clustering algorithm by polling of WiFi access points for a change in nearby WiFi access points. The sensor data stream (e.g., the first sensor data stream) may originate from a WiFi sensor and the transition event may be defined by detection of a number of new or different WiFi access points. For example, in response to first detection new or different WiFi access points the start of a segment is triggered, and the end of the segment can be determined when additional WiFi access are discovered.

In one embodiment, TTCM collects sensor data and determines features of bluetooth (BT) fingerprints, including sets of visible BT devices, their respective signal strengths (e.g., given as RSSI), their device classes, and their respective response rates. Each segment or cluster can correspond to a distinct BT environment.

In one embodiment, TTCM collects sensor data and determines features of motion states of the device, including accelerometer, gyroscope and/or magnetometer data. Motion data may be obtained over a specified duration (e.g., approximately 10-30 seconds). Each segment or cluster can correspond to a distinct set of motions such as walking, running, sitting, standing, or other motion inferred from features within a sensor data stream.

In one embodiment, TTCM collects sensor data and determines features of calendar events, including calendar descriptions and/or titles, dates/times, locations, names of attendees and/or other associated people, etc. Each segment or cluster can correspond to a set of events with similar names, locations, or other attributes.

At block 225, the embodiment can process the second sensor data stream as a context label for a segment of the first sensor data stream, wherein the segment beginning is defined by the first status change. For example, TTCM may record the audio data stream from a mobile device's microphone for a predetermined period of time less than or equal to the duration of the respective segment or cluster. Segments and clusters may be defined according to status changes of one or more respective features (e.g., within the intermittent sensor data stream). For example, a start or beginning of a segment may be defined by the status change of a feature. The end of a segment may be defined by the feature reverting back to the original status, or changing to some other predetermined status. The device may end a segment by suspending, closing, or otherwise halting the sensor data stream associated with the segment. In some embodiments the sensor data stream used as the context label is collected and stored to local device memory or uploaded to a server.

In one embodiment, context labeling is transparent to the person whose lifestyle/high-level context is being analyzed or monitored. For example, a third party can determine context from on a prerecorded data sample (e.g., retroactively). For example, a third party (e.g., parents, caregivers, etc.) can replay the continuous audio recording, images, or video at a later point of time to understand how the device and user (e.g., children, elderly adult, patient, etc.) spent their day. Upon reviewing the saved information, the parents may assign a context label to the continuous audio recording, images, or video and the initial segment or cluster can be classified. In one embodiment, in response to determining a transition event two or more additional sensor data streams may be activated. For example, an audio recording and camera sensor may be triggered. When a set of sensor streams define a segment or cluster, the entire set may be associated with the resulting context label.

In other embodiments, a server or the mobile device may determine the high level context. For example, instead of or in addition to third party created context labels, TTCM (implemented on the mobile device or at a remote server) can infer statistically or otherwise, the context label from features of low-level inferences as described above. The server or mobile device may learn from user classifications in order to improve future automated labels or classifications relating to context. For example, TTCM may fingerprint a segment such that when a similar segment occurs it can automatically match a prior determined context label.

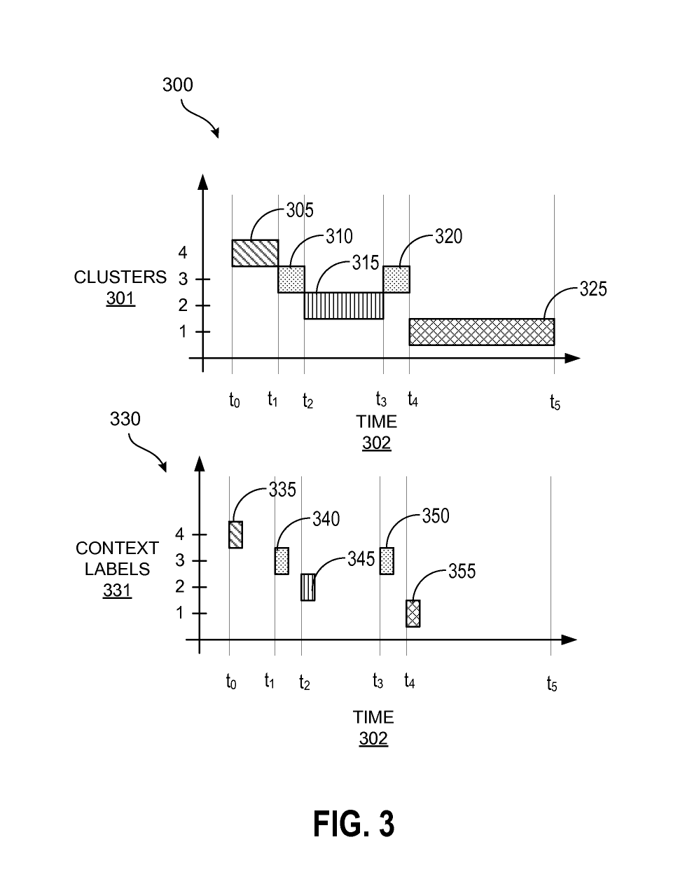

FIG. 3 illustrates an exemplary time chart for clustering and context labeling. Diagram 300 illustrates clusters or segments 1-4 (e.g., clusters 301) representing data points grouped in time exhibiting similar feature profiles. Each segment or cluster 305-325 may correspond to any predefined grouping of features and/or sets of features determined from a sensor data stream.

Transitions (e.g., a feature status change, transition event, or change-point detection) are indicated by time 302 t₀-t₅ illustrated in FIG. 3, diagram 300. In response to detecting data (e.g., features) of a sensor stream changes properties compared to the current segment or cluster, TTCM can trigger a transition to a new segment or cluster. In one embodiment, transitions events or change-point detection can include detecting current features consistently have distinctly different values than from a previous data sample (e.g., an earlier time). In a probabilistic setting, change-point detection may include detecting that the underlying distribution from which the current features are being drawn is distinctly different from the underlying distribution from which the features were drawn at an earlier time. For example, in a first time period the audio feed from the microphone may be classified as a quiet state as determined from features of the audio sensor data. At a second time period, features of the audio sensor data may infer that a speech state is the next current classification.

Diagram 330 illustrates that with each transition, a context label 331 may be created and associated with each respective segment or cluster. For example, an audio recording, video recording, motion monitor, position tracker, or other implementation may be initiated with an additional sensor data stream. Each context label 335-355 may be of a shorter duration (e.g., as roughly indicated by time 302) than the respective segment or cluster. In some embodiments, the same sensor as the respective segment may be initiated with a different data sampling rate (e.g., audio sample rate) and duration. In some embodiments, the context label is a placeholder saved for retroactive labeling by the user, a third party, or sent to a server as discussed herein. For example, a context label including a continuous audio feed “X” may be saved as a “black box” of unknown content. TTCM can save the context label including audio feed “X” to non-volatile memory and associate “X” with time slot or block indicating time of capture. In some embodiments, audio feed “X” may not be interpreted by a third party of an automated system until a subsequent event causes a detailed or updated context label to be applied. For example, a third party may review “X” to determine that it represents a context label of “children watching television.”

The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

TTCM may be implemented as software, firmware, hardware, module (e.g., TTCM module 171) or engine. In one embodiment, the previous TTCM description (e.g., the method illustrated in FIG. 2) may be implemented by the general purpose processor (e.g., processor 101 in device 100) to achieve the previously desired functions.

It should be appreciated that when the device 100 is a mobile or wireless device that it may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an Electrocardiography (EKG) device, etc.), a user I/O device, a computer, a server, a point-of-sale device, an entertainment device, a set-top box, or any other suitable device. These devices may have different power and data requirements and may result in different power profiles generated for each feature or set of features.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for monitoring context associated with a mobile device, the method comprising:
receiving a first sensor data stream comprising data from one or more sensors at the mobile device;
monitoring one or more features calculated from the data of the first sensor data stream;
detecting a first status change for one or more features within the first sensor data stream;
triggering, in response to detecting the first status change, collection of a second sensor data stream comprising data from one or more sensors at the mobile device; and
processing the second sensor data stream as a context label for a segment of the first sensor data stream, wherein the segment beginning is defined by the first status change.

2. The method of claim 1, wherein, in response to detecting a second status change for the one or more features within the first sensor data stream, finalizing the context label by marking an end of the segment and suspending the collection of the second sensor data stream.

3. The method of claim 1, wherein the first sensor data stream is collected intermittently and the second sensor data stream is collected as a continuous sensor data stream.

4. The method of claim 1, wherein the processing the second sensor data stream further comprises one or more of: recording the second sensor data stream to non-volatile memory for subsequent user analysis, or automatically creating a context label for the segment according to features calculated from the second sensor data stream.

5. The method of claim 1, wherein the first and second sensor data stream is from one or more of: accelerometer, gyroscope, magnetometer, clock, global positioning system, WiFi, Bluetooth, ambient light sensor, microphone, or camera sensor.

6. The method of claim 1, wherein the first and second sensor data stream are audio streams from a microphone, wherein the first sensor data stream is a different audio sample rate and duration than the second sensor data stream, and wherein the second sensor data stream is a continuous data sample for a predetermined duration less than the first sensor data stream.

7. The method of claim 1, wherein the triggering further comprises:
checking a privacy setting before enabling the second sensor data stream, the privacy setting comprising one or more of:
allowable duration of the second sensor data stream,
type of sensor authorized to initiate a second sensor data stream,
one or more authorized locations for enabling the second sensor data stream, or
detection of one or more nearby devices or users.

8. A machine readable non-transitory storage medium containing executable program instructions which cause a data processing device to perform a method for monitoring context associated with a mobile device, the method comprising:
receiving a first sensor data stream comprising data from one or more sensors at the mobile device;
monitoring one or more features calculated from the data of the first sensor data stream;
detecting a first status change for one or more features within the first sensor data stream;
triggering, in response to detecting the first status change, collection of a second sensor data stream comprising data from one or more sensors at the mobile device; and
processing the second sensor data stream as a context label for a segment of the first sensor data stream, wherein the segment beginning is defined by the first status change.

9. The medium of claim 8, wherein, in response to detecting a second status change for the one or more features within the first sensor data stream, finalizing the context label by marking an end of the segment and suspending the collection of the second sensor data stream.

10. The medium of claim 8, wherein the first sensor data stream is received intermittently and the second sensor data stream is collected as a continuous sensor data stream.

11. The medium of claim 8, wherein the processing the second sensor data stream further comprises one or more of: recording the second sensor data stream to non-volatile memory for subsequent user analysis, or automatically creating a context label for the segment according to features calculated from the second sensor data stream.

12. The medium of claim 8, wherein the first and second sensor data stream is from one or more of: accelerometer, gyroscope, magnetometer, clock, global positioning system, WiFi, Bluetooth, ambient light sensor, microphone, or camera sensor.

13. The medium of claim 8, wherein the first and second sensor data stream are audio streams from a microphone, wherein the first sensor data stream is a different audio sample rate and duration than the second sensor data stream, and wherein the second sensor data stream is a continuous data sample for a predetermined duration less than the first sensor data stream.

14. The medium of claim 8, wherein the triggering further comprises:
checking a privacy setting before enabling the second sensor data stream, the privacy setting comprising one or more of:
allowable duration of the second sensor data stream,
type of sensor authorized to initiate a second sensor data stream,
one or more authorized locations for enabling the second sensor data stream, or
detection of one or more nearby devices or users.

15. A data processing device comprising:
a processor;
a storage device coupled to the processor and configurable for storing instructions, which, when executed by the processor cause the processor to:
receive a first sensor data stream comprising data from one or more sensors at the mobile device;
monitor one or more features calculated from the data of the first sensor data stream;
detect a first status change for one or more features within the first sensor data stream;
trigger, in response to detecting the first status change, collection of a second sensor data stream comprising data from one or more sensors at the mobile device; and
process the second sensor data stream as a context label for a segment of the first sensor data stream, wherein the segment beginning is defined by the first status change.

16. The device of claim 15, wherein, in response to detecting a second status change for the one or more features within the first sensor data stream, finalizing the context label by marking an end of the segment and suspending the collection of the second sensor data stream.

17. The device of claim 15, wherein the first sensor data stream is received intermittently and the second sensor data stream is collected as a continuous sensor data stream.

18. The device of claim 15, wherein the processing the second sensor data stream further comprises one or more of: recording the second sensor data stream to non-volatile memory for subsequent user analysis, or automatically creating a context label for the segment according to features calculated from the second sensor data stream.

19. The device of claim 15, wherein the first and second sensor data stream is from one or more of: accelerometer, gyroscope, magnetometer, clock, global positioning system, WiFi, Bluetooth, ambient light sensor, microphone, or camera sensor.

20. The device of claim 15, wherein the first and second sensor data stream are audio streams from a microphone, wherein the first sensor data stream is a different audio sample rate and duration than the second sensor data stream, and wherein the second sensor data stream is a continuous data sample for a predetermined duration less than the first sensor data stream.

21. The device of claim 15, wherein the triggering further comprises instructions to:
check a privacy setting before enabling the second sensor data stream, the privacy setting comprising one or more of:
allowable duration of the second sensor data stream,
type of sensor authorized to initiate a second sensor data stream,
one or more authorized locations for enabling the second sensor data stream, or
detection of one or more nearby devices or users.

22. An apparatus for monitoring context associated with a mobile device comprising:
means for receiving a first sensor data stream comprising data from one or more sensors at the mobile device;
means for monitoring one or more features calculated from the data of the first sensor data stream;
means for detecting a first status change for one or more features within the first sensor data stream;
means for triggering, in response to detecting the first status change, collection of a second sensor data stream comprising data from one or more sensors at the mobile device; and
means for processing the second sensor data stream as a context label for a segment of the first sensor data stream, wherein the segment beginning is defined by the first status change.

23. The apparatus of claim 22, wherein, in response to detecting a second status change for the one or more features within the first sensor data stream, finalizing the context label by marking an end of the segment and suspending the collection of the second sensor data stream.

24. The apparatus of claim 22, wherein the first sensor data stream is received intermittently and the second sensor data stream is collected as a continuous sensor data stream.

25. The apparatus of claim 22, wherein the processing the second sensor data stream further comprises one or more of: recording the second sensor data stream to non-volatile memory for subsequent user analysis, or automatically creating a context label for the segment according to features calculated from the second sensor data stream.

26. The apparatus of claim 22, wherein the first and second sensor data stream is from one or more of: accelerometer, gyroscope, magnetometer, clock, global positioning system, WiFi, Bluetooth, ambient light sensor, microphone, or camera sensor.

27. The apparatus of claim 22, wherein the first and second sensor data stream are audio streams from a microphone, wherein the first sensor data stream is a different audio sample rate and duration than the second sensor data stream, and wherein the second sensor data stream is a continuous data sample for a predetermined duration less than the first sensor data stream.

28. The apparatus of claim 22, wherein the triggering further comprises:
means for checking a privacy setting before enabling the second sensor data stream, the privacy setting comprising one or more of:
allowable duration of the second sensor data stream,
type of sensor authorized to initiate a second sensor data stream,
one or more authorized locations for enabling the second sensor data stream, or
detection of one or more nearby devices or users.
